(19) United States
(12) Patent Application Publication
(10) Pub. No.: US 2009/0168110 A1
(43) Pub. Date: Jul. 2, 2009

(54) Content Transmitting Apparatus, Content Receiving Apparatus, and Content Transmitting Method

(75) Inventor: Chikara Ushimaru, Hamura-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/327,752

(22) Filed: Dec. 3, 2008

(30) Foreign Application Priority Data
Dec. 27, 2007 (JP) 2007-338212

(51) Int. Cl. G06K 15/00

(52) U.S. Cl. 358/3.28; 726/31

(57) ABSTRACT

According to one embodiment, a content transmitting apparatus which encrypts a content item which is copy controlled to limit the number of permitted copies and transmits the encrypted content item to a sink device, includes a number-of-copies information transmitting module configured to transmit number-of-copies information representing the number of permitted copies to the sink device as plaintext.

### CROSS-REFERENCE TO RELATED APPLICATIONS

This application is based upon and claims the benefit of priority from Japanese Patent Application No. 2007-338212, filed Dec. 27, 2007, the entire contents of which are incorporated herein by reference.

### BACKGROUND

1. Field

One embodiment of the invention relates to transmission of content the number of permitted copies of which is protected and, more particularly, to a content transmitting apparatus, a content receiving apparatus, and a content transmitting method.

2. Description of the Related Art

At present, development of a home network technique is advanced by the Digital Living Network Association (DLNA) or the like, and content items stored in an in-home apparatus can be viewed by another apparatus through a network. Not only viewing of content items but also moving of content items between apparatuses through a network by using DTCP-IP are realized (see DTCP Volume 1, Supplement E, Mapping DTCP to IP [Informational Version] Revision 1.2, Jun. 15, 2007).

At present, there is movement of moderating copy-once restriction of digital broadcasting. It is expected that one content item can be copied two or more times.

However, in the DTCP-IP, content items which can be copied two or more times are not considered. For this reason, when a content item is moved, the number of permitted copies of the content item held by a content transmitting apparatus is reduced by one, the content item is moved to a content receiving apparatus, and the content item received by the content receiving apparatus must be handled as NoMoreCopies which cannot be copied any more. If a content item which can be copied ten times is copied in another apparatus with three out of the ten permitted copies, exactly the same transfer must be repeated three times, i.e., a processing time is required for the three times of transfer. In the receiving apparatus, since even the same content items are respectively handled as different content items every transfer, a storage area for three content items is disadvantageously necessary.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a configuration of a content transmitting system according to an embodiment of the present invention;

FIG. 2 is an exemplary diagram showing a procedure of a content transmitting method; and

FIG. 3 is an exemplary diagram showing a procedure of an authority transfer process.

### DETAILED DESCRIPTION

Various embodiments according to the invention will be described hereinafter with reference to the accompanying drawings. In general, according to one embodiment of the invention, a content transmitting apparatus which encrypts a content item which is copy controlled to limit the number of permitted copies and transmits the encrypted content item to a sink device, comprises a number-of-copies information transmitting module configured to transmit number-of-copies information representing the number of permitted copies to the sink device as plaintext.

### First Embodiment

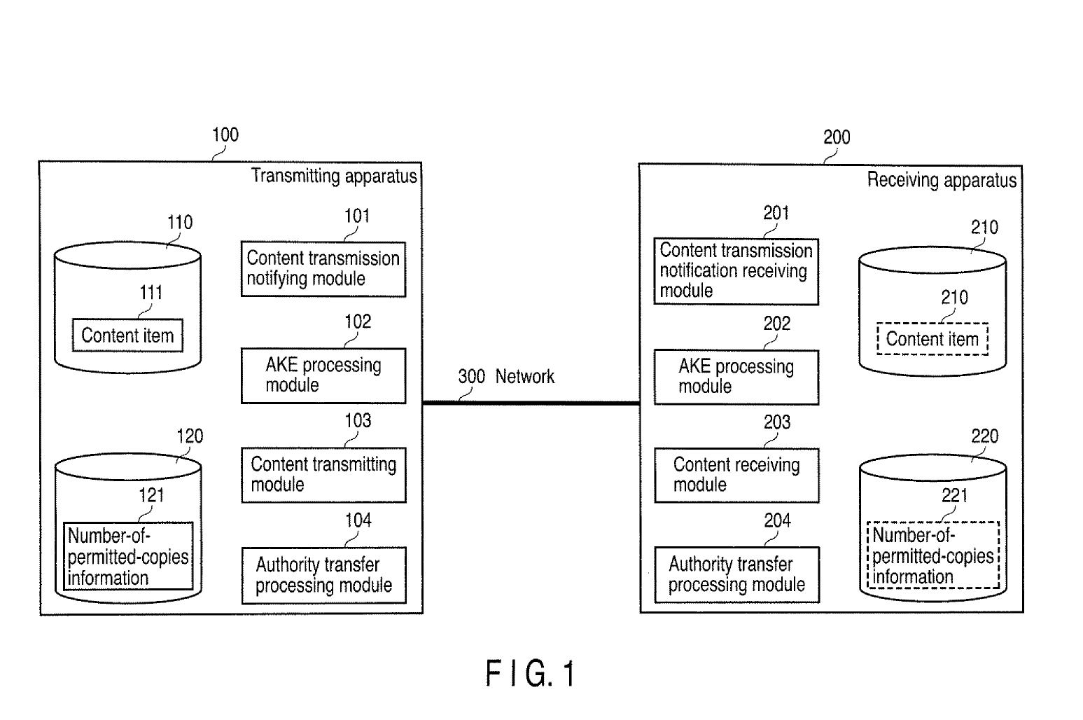

FIG. 1 is a diagram typically showing a configuration of a content transmitting system according to a first embodiment of the present invention.

The system supposed by the embodiment includes a transmitting apparatus 100 and a receiving apparatus 200. These apparatuses are connected to each other through a network 300. The network includes an IP network such as Ethernet (registered trademark).

The transmitting apparatus 100 includes a content transmission notifying module 101, an AKE processing module 102, a content transmitting module 103, an authority transfer processing module 104, a hard disk drive 110, a secure storage device 120, and the like. A content item 111 to be transmitted to the receiving apparatus 200 is stored in the hard disk drive 110. Number-of-permitted-copies information 121 of the content item 111 is stored in a secure storage device 120.

The receiving apparatus 200 includes a content transmission notification receiving module 201, an AKE processing module 202, a content receiving module 203, an authority transfer processing module 204, a hard disk drive 210, a secure storage device 220, and the like. A content item 211 received from the transmitting apparatus 100 is stored in the hard disk drive 210. Number-of-permitted-copies information 221 of the content item 211 is stored in the secure storage device 220.

In the transmitting apparatus 100, when a content item is moved, the number of times to be moved is associated with content transmission as the number-of-permitted-copies information under the transfer. Upon completion of content movement, the number-of-permitted-copies information 121 managed by the transmitting apparatus 100 is updated. In the receiving apparatus 200, upon completion of content movement, the number-of-permitted-copies information 221 is managed based on the number-of-permitted-copies information.

In this system, the apparatuses 100 and 200 have functions of transmitting/receiving content items through networks like, for example, a DLNA capable device. The apparatuses have a copyright protecting function such as DTCP.

The DTCP capable devices can move content items therebetween. A transmitting apparatus and a receiving apparatus are connected by an IEEE 1394 or IP network, authentication and key exchange are performed between the apparatuses to perform copyright protection by encryption, and the content items are moved from the transmitting apparatus to the receiving apparatus.

A method of protecting the number-of-permitted-copies information of the content item 111 moved from the transmitting apparatus 100 to the receiving apparatus 200 and notifying the receiving apparatus 200 of the number-of-permitted-copies information.

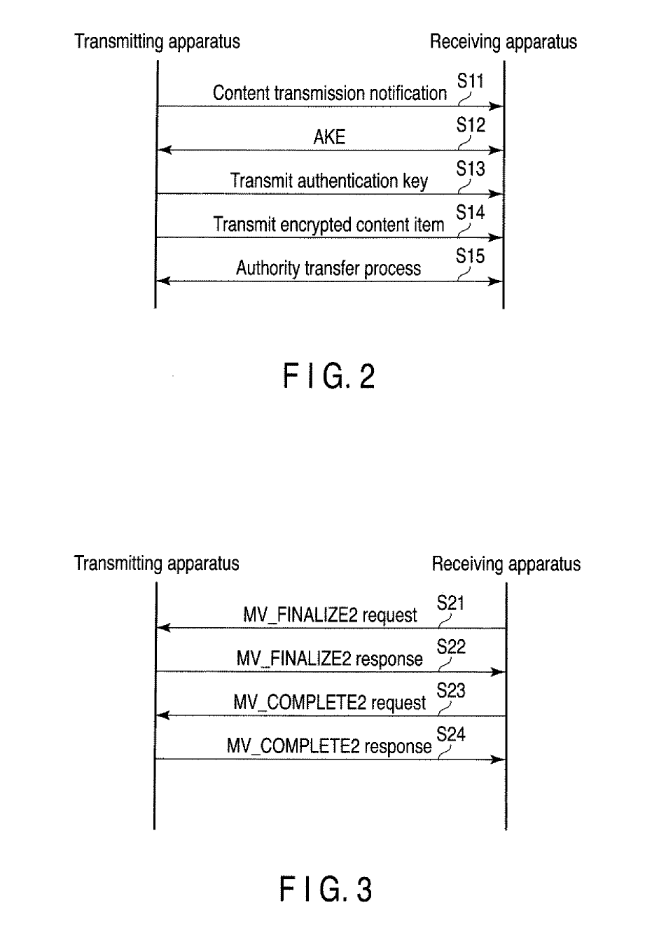

The method of moving a content item restricted by the DTCP will be described below with reference to FIG. 2.

The content transmission notifying module 101 of the transmitting apparatus 100 notifies the receiving apparatus 200 of transmission of a content item from the transmitting apparatus 100 (block S11). This notification is received by the content transmission notification receiving module 201 of the receiving apparatus 200. First, one TCP/IP connection is established between the transmitting apparatus 100 and the receiving apparatus 200.

The AKE processing modules 102 and 202 perform authentication with each other apparatus (block S12). This authentication is called DTCP authentication or Authentication and Key Exchange (AKE). In a DTCP authentication procedure, after it is confirmed that the transmitting apparatus 100 and the receiving apparatus 200 are normal DTCP compatible apparatuses, an authentication key Kₐᵤₜₕ can be shared by the transmitting apparatus 100 and a sink device.

When an AKE procedure is successful, the transmitting apparatus 100 generates a seed key Kₓ serving as a seed of a content key, encrypts the seed key Kₓ by the authentication key Kₐᵤₜₕ, and sends the encrypted key to the receiving apparatus 200 (block S13). The transmitting apparatus 100 generates 64-bit Nonce (N_{c}) by using a random number, and generates a content key K_{c} based on the seed key Kₓ, the nonce N_{c}, and an E-EMI representing an encryption mode.

The content transmitting module 103 of the transmitting apparatus 100 encrypts the content item by using the content key K_{c} and transmits a packet (Protected Content Packet [PCP]) including the encrypted content item, the nonce N_{c}, and the E-EMI in a header to the receiving apparatus 200 on a TCP stream (block S14). On the other hand, in the content receiving module 203 of the receiving apparatus 200, when the nonce Nc and the E-EMI are extracted from the TCP stream, the content key K_{c} is similarly calculated by using the nonce N_{c}, the E-EMI, and the key Kₓ to decrypt the encrypted content item.

Upon completion of transmission of the content item, a transfer process of a content use right called a Move Commitment is performed between the authority transfer processing modules 104 and 204 (block S15). At this time, in order to secure that a message is not falsified, a value called a MAC calculated by using information which can be known only by the transmitting apparatus 100 and the receiving apparatus 200 is given. Upon completion of the transfer process, the content item can be used in the receiving apparatus 200.

As described above, in the DTCP-IP, a content item to be protected is packeted, encrypted, and then transmitted. In the embodiment, the number of permitted copies is embedded in a header of a packet to transmit the number of permitted copies from a source to a sink device.

Table 1 shows a data structure of the header of the packet employed by the embodiment.

TABLE 1

| | msb | | lsb |
|---|---|---|---|
| Header[0] | reserved | C_A | E-EMI |
| | (zero) | | |

| | |
|---|---|
| Header[1] | exchange_key_label |
| Header[2] | N_{C} (64 bits) |
| Header[3] | |
| Header[4] | |
| Header[5] | |
| Header[6] | |
| Header[7] | |
| Header[8] | |
| Header[9] | |
| Header[10] | Byte length of content |
| Header[11] | denoted as CL |
| Header[12] | (32 bits) |
| Header[13] | |
| EC[0] | Content affixed with |
| EC[1] | 0 to 15 bytes |
| EC[2] | of padding |
| — | |
| — | |
| — | |
| EC[N − 1] | |

In Header [2 . . . 9], a nonce N_{c} serving as a 64-bit random number is stored.

Table 2 shows a nonce N_{c} field.

TABLE 2

| | |
|---|---|
| msb | lsb |

| | |
|---|---|
| N_{C}[0] | PCP-UR (16 bits) |
| N_{C}[1] | |
| N_{C}[2] | SN_{C} (48 bits) |
| N_{C}[3] | |
| N_{C}[4] | |
| N_{C}[5] | |
| N_{C}[6] | |
| N_{C}[7] | |

As shown in Table 2, the N_{c} field is divided into a 16-bit PCP-UR field and a 48-bit SN_{c} field.

Table 3 shows details of the PCP-UR field.

TABLE 3

| | msb | | | | lsb |
|---|---|---|---|---|---|
| PCP- | UR | Content | APS | ICT | Reserved |
| UR[0] | Mode | Type | | | |

| | |
|---|---|
| PCP- | The Number of Permitted Copies |
| UR[1] | |

In the embodiment, at the present standard, the number of permitted copies is embedded in the PCP-UR [1] serving as a Reserved field, and the number of permitted copies is transmitted to the receiving apparatus side as plaintext. As information on the number of permitted copies, the number of permitted copies to be moved by the transmitting apparatus 100 is set. The sink device can know the number of permitted copies of the content item included in an encrypted packet by the number-of-permitted-copies information of the encrypted packet header.

Since the number-of-permitted-copies information transmitted onto a network is not encrypted, the number-of-permitted-copies information may be falsified. Since the nonce NC including the number-of-permitted-copies information is information used when a content key for encrypting a content item as described above, if falsification is performed, the content item cannot be correctly decrypted at the receiver side, and the number of permitted copies cannot be illegally manipulated.

### Second Embodiment

A method of confirming number-of-permitted-copies information between the transmitting apparatus 100 and the receiving apparatus 200 while protecting the number-of-permitted-copies information in content use right transfer wilt be described below.

In a DTCP-IP, in moving a content item, a transfer process of a content use right called a Move Commitment is performed. At this time, in order to secure that a message is not falsified, a value called a MAC calculated by using information which can be known only by a transmitting apparatus and a receiving apparatus which performs authentication and key exchange is given.

In this proposal, MV_FINALIZE subfunction is shown in Table 4 and Table 5. Extension is performed as shown in Table 4 and Table 5, and number-of-permitted-copies information is confirmed in Move Commitment.

TABLE 4
MV_FINALIZE2 subfunction Command

| | |
|---|---|
| msb | lsb |

| | |
|---|---|
| AKE_info[0] | K_{XM}_{_{—}}label |
| — | |
| AKE_info[x] | P (64 bit) |
| — | |
| AKE_info[x + 7] | |
| — | |
| AKE_info[y] | Number of Permitted Copies [n] |
| — | |
| AKE_info[z] | MAC7A |
| — | |
| AKE_info[z + 9] | |

TABLE 5
MV_FINALIZE2 subfunction Response

| | |
|---|---|
| msb | lsb |

| | |
|---|---|
| AKE_info[0] | K_{XM}_{_{—}}label |
| — | |
| AKE_info[x] | P (64 bit) |
| — | |
| AKE_info[x + 7] | |
| — | |
| AKE_info[y] | Number of Permitted Copies [N] |
| — | |
| AKE_info[z] | MAC8B |
| — | |
| AKE_info[z + 9] | |

MAC7A (32) and MAC8B (42) are calculated as follows:

MAC7A=MAC7B=[SHA−1(MJ+P+N)]msb80

MAC8A=MAC8B=[SHA−1(MJ+P+N)]lsb80,

where N is the number of permitted copies. MJ and P are given as described in MV_FINALIZE subfunction of the DTCP-IP standard.

In the embodiment, in content transmission notification in block S11 in FIG. 2, the content transmission notifying module 101 of the transmitting apparatus 100 notifies the receiving apparatus 200 of the content item together with the number-of-permitted-copies information of the content item to be moved as plaintext.

The number-of-permitted-copies information is confirmed while being protected when the authority is transferred in block S15. The procedure of the authority transfer process will be described with reference to FIG. 3.

Upon completion of the content transfer process, an MV_FINALIZE2 request is transmitted from the authority transfer processing module 204 of the receiving apparatus 200 (block S21).

The authority transfer processing module 104 of the transmitting apparatus 100 decrease the number-of-permitted-copies information 121 in the transmitting apparatus 100 by N when MAC7A transmitted from the receiving apparatus 200 is matched with MAC7B calculated by the authority transfer processing module 104, and returns an MV_FINALIZE2 response as successful (block S22).

In the receiving apparatus 200, when MAC8B received at this time is matched with MAC8A calculated in the receiving apparatus, the number-of-permitted-copies information 221 of the received content item 211 is managed as N times in the receiving apparatus 200. When the number of permitted copies in the content transmission notification (block S1) or the MV_FINALIZE2 request (block S1) is falsified, the MACs are different from each other, and then the content transfer is interrupted. For this reason, the number of permitted copies cannot be illegally manipulated.

The receiving apparatus 200 transmits an MV_COMPLETE2 request to finish the process to the transmitting apparatus 100 (block S23). The transmitting apparatus 100 returns an MV_COMPLETE2 response to the receiving apparatus 200 when the transmitting apparatus 100 acknowledges the end of the process (block S24).

In this manner, the number of permitted copies notified from the transmitting apparatus at the start of transmission is confirmed in a Move Commitment process while being protected by using information which can be known only by the transmitting apparatus and the receiving apparatus, so that the number of permitted copies of a content item to be moved can be correctly transmitted.

### Third Embodiment

A method of notifying transfer of a content item together with the number of permitted copies will be described below. In this proposal, the transmitting apparatus also notifies the number of permitted copies in the content transmission notification (block S11).

It is assumed that, in DTCP-IP, an encryption mode and copy control information are notified by an Encryption Mode Indicator (E-EMI) (Header[0] in Table 1) of the header of an encrypted packet. In this embodiment, a mode with the number of permitted copies is newly added as the encryption mode.

Present E-EMI (4-bit) bit value definitions are shown in Table 6.

TABLE 6

| E-EMI | Encryption | |
|---|---|---|
| value | Mode | Copy control Information |
| 1100 | Mode A0 | Copy-never (CN) |
| 1010 | Mode B1 | Copy-one-generation (COG) |
| | | [Format-cognizant |
| | | recording only] |
| 1000 | Mode B0 | Copy-one-generation (COG) |
| | | [Format-non-cognizant |
| | | recording permitted] |
| 0110 | Mode C1 | Move [Audiovisual] |
| 0100 | Mode C0 | No-more-copies (NMC) |
| 0010 | Mode D0 | Copy-free with EPN asserted |
| | | (CF/EPN) |
| 0000 | N.A. | Copy-free (CF) |
| — | | All other values reserved |

At present, E-EMI values of seven types are defined, and remaining nine E-EMI values are not defined. The number of permitted copies (for example, 1 to 9) is allocated to each of the undefined E-EMI values.

In this manner, it is detected in advance or immediately after the start of content transfer that an apparatus which supports only a past version of the DTCP-IP cannot cope. Thus, loss of content items or unnecessary content transfer can be avoided.

As described in the embodiments, in a content moving process between the apparatuses through a network, number-of-permitted-copies information is associated with a header of an encrypted packet or a content use right transfer request while being protected. In this manner, for example, when a content item which can be copied ten times is recorded by a certain apparatus, it is possible to transmit the content item assigned with the number of permitted copies for several times of copies in one transmission. Therefore, a content transfer process does not need to be repeated the number of times of copies to be permitted. Also in the receiving apparatus, it is advantageous that a content storage area for the number of permitted copies of content items does not need to be secured.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A content transmitting apparatus which encrypts a content item which is copy controlled to limit the number of permitted copies and transmits the encrypted content item to a sink device, comprising:
a number-of-copies information transmitting module configured to transmit number-of-copies information representing the number of permitted copies to the sink device as plaintext.

2. The content transmitting apparatus of claim 1, wherein the number-of-copies information transmitting module generates a packet including a header having the number-of-copies information of the plaintext and a payload obtained by encrypting the content item by a content key generated by using information including the number-of-copies information to transmit the packet to the sink device.

3. The content transmitting apparatus of claim 2, wherein the number-of-copies information of the plaintext is stored in a nonce N_{c}.

4. The content transmitting apparatus of claim 2, wherein the number-of-copies information of the plaintext is an E-EMI representing an encryption mode and copy control information.

5. The content transmitting apparatus of claim 1, wherein the number-of-copies information transmitting module notifies the sink device of the number of permitted copies as plaintext when the sink device is notified that the content item is transmitted, and
the content transmitting apparatus further includes a confirmation module configured to, in use right transfer of the content item after the end of transmission of the content item, exchange MAC values generated from the number of permitted copies with the sink device to confirm the use right transfer of the content item.

6. A content receiving apparatus which receives by a source device a content item being copy controlled to limit the number of permitted copies and encrypted, comprising:
a number-of-copies information receiving module configured to receive number-of-copies information representing the number of permitted copies transmitted from the source device as plaintext; and
a storing module configured to store the number of permitted copies depending on the received number-of-copies information in a protected storage device.

7. The content receiving apparatus of claim 6, wherein the number-of-copies information receiving module receives a packet including a header having the number-of-copies information of the plaintext and a payload obtained by encrypting the content item by a content key generated by using information including the number-of-copies information.

8. The content receiving apparatus of claim 7, wherein the number-of-copies information of the plaintext is stored in a nonce N_{c}.

9. The content receiving apparatus of claim 7, wherein the number-of-copies information of the plaintext is an E-EMI representing an encryption mode and copy control information.

10. The content receiving apparatus of claim 6, wherein the source device notifies the number-of-copies information receiving module of the number of permitted copies as plaintext when the source device notifies that the content item is transmitted, and
the content receiving apparatus further includes a confirmation module configure to, in use right transfer of the content item after the end of transmission of the content item, exchanges MAC values generated from the number of permitted copies with the source device to confirm the use right transfer of the content item.

11. A content transmitting method of encrypting a content item being copy controlled to limit the number of permitted copies and transmitting the encrypted content item from a source device to a sink device, comprising:
transmitting number-of-copies information representing the number of permitted copies as plaintext from the source device to the sink device; and
storing by the sink device the number of permitted copies depending on the received number-of-copies information in a protected storage device.

12. The content transmitting method of claim 11, wherein a packet including a header having the number-of-copies information of the plaintext and a payload obtained by encrypting the content item by a content key generated by using information including the number-of-copies information is generated, and the generated packet is transmitted to the sink device.

13. The content transmitting method of claim 12, wherein the number-of-copies information of the plaintext is stored in a nonce N_{c}.

14. The content transmitting method of claim 12, wherein the number-of-copies information of the plaintext is an E-EMI representing an encryption mode and copy control information.

15. The content transmitting method of claim 11, wherein the source device notifies the sink device of the number of permitted copies as plaintext when the source device notifies the sink device that the content item is transmitted, and
in use right transfer of the content item after the end of transmission of the content item, the source device exchanges MAC values generated from the number of permitted copies with the sink device to confirm the use right transfer of the content item.
